(19) United States
(12) Patent Application Publication
(10) Pub. No.: US 2026/0213700 A1
(43) Pub. Date: Jul. 23, 2026

(54) TRANSPARENT DISPLAY DEVICE CAPABLE OF SOLAR CHARGING

(71) Applicant: SAMSUNG ELECTRONICS CO., LTD., Suwon-si (KR)

(72) Inventors: Yunsoo CHOI, Suwon-si (KR); Byunghwa Lee, Suwon-si (KR); Kwanhee Lee, Suwon-si (KR)

(73) Assignee: SAMSUNG ELECTRONICS CO., LTD., Suwon-si (KR)

(21) Appl. No.: 19/450,440

(22) Filed: Jan. 15, 2026

Related U.S. Application Data
(63) Continuation of application No. PCT/KR2025/023328, filed on Dec. 31, 2025.

(30) Foreign Application Priority Data
Dec. 31, 2024 (KR) 10-2024-0202420

(51) Int. Cl. H02S 20/32; G06F 3/01; G09G 5/10

(52) U.S. Cl. CPC H02S 20/32; G06F 3/013; G09G 5/10; G09G 2320/0626; G09G 2330/02; G09G 2354/00; G09G 2360/144; G09G 2370/022

(57) ABSTRACT

A display device may include a blind device including one or more rotatable slits and one or more solar panels on a surface of the corresponding slit, a transparent display provided behind the blind device, memory storing one or more instructions, and at least one processors configured to control the blind device and the transparent display. The one or more instructions, when individually or collectively executed by the at least one processor, may cause the display device to: identify a power generation time period as a main power generation time or a sub power generation time based on an installation position of the display device, adjust a rotation angle of the one or more rotatable slits based on the power generation time period, and adjust a luminance of the transparent display based on the rotation angle of the one or more rotatable slits.

### CROSS-REFERENCE TO RELATED APPLICATIONS

This application is a continuation application of International Application No. PCT/KR2025/023328, filed on Dec. 31, 2025, which claims priority to Korean Patent Application No. 10-2024-0202420, filed on Dec. 31, 2024, in the Ministry of Intellectual Property, the disclosures of which are incorporated by reference herein in their entireties.

### BACKGROUND

### 1. Field

The disclosure relates to a transparent display device capable of solar charging.

### 2. Description of Related Art

Various types of display devices are being used in various fields. In particular, research and discussion on next-generation display devices such as transparent display devices has been accelerating recently.

A transparent display device refers to a device with a transparent display panel that allows objects behind the device to be visible through it. Display panels have been manufactured using opaque semiconductor compounds such as silicon (Si) and gallium arsenide (GaAs), but as various application fields that may not be handled by existing display panels have been developed, development efforts for new types of electronic devices have been made. One of the developments under such efforts is the transparent display device.

The transparent display device may be installed in a place like a window so as to maintain the function of a window through which the outside may be seen while performing a function of displaying digital content in terms of space utilization.

However, when the transparent display device is installed in a place like a window, visibility of content output on the screen may be deteriorated by natural light reflected or transmitted on the display screen.

The above-described information may be provided as related art for the purpose of helping understanding of the disclosure. No claim or determination is made as to whether any of the foregoing is applicable as background art in relation to the disclosure.

### SUMMARY

According to an aspect of the disclosure, there is provided a display device. The display device may include: a blind device including one or more rotatable slits and one or more solar panels on a surface of the corresponding slit; a transparent display provided behind the blind device; memory storing one or more instructions; and at least one processor configured to control the blind device and the transparent display. The one or more instructions, when individually or collectively executed by the at least one processor, may cause the display device to: identify a power generation time period as a main power generation time or a sub power generation time based on an installation position of the display device; adjust a rotation angle of the one or more rotatable slits based on the identified power generation time period; and adjust a luminance of the transparent display based on the rotation angle of the one or more rotatable slits.

According to an aspect of the disclosure, there is provided a method for controlling a display device. The method may include: identifying whether a power generation time period is a main power generation time or a sub power generation time based on an installation position of the display device; adjusting a rotation angle of one or more rotatable slits based on the identified power generation time period; and adjusting a luminance of a transparent display based on the rotation angle of one or more rotatable slits.

The disclosure is not limited to the foregoing embodiments but various modifications or changes may rather be made thereto without departing from the spirit and scope of the disclosure.

### BRIEF DESCRIPTION OF THE DRAWINGS

The above and other aspects and/or features of embodiments of the present disclosure will be more apparent from the following description taken in conjunction with the accompanying drawings, in which:

FIG. 1 is a partial cross-sectional perspective view illustrating a display device according to an embodiment of the disclosure;

FIG. 2 is an exploded perspective view illustrating a partial configuration of a display device according to an embodiment of the disclosure;

FIG. 3 is a control block diagram illustrating a display device according to an embodiment of the disclosure;

FIG. 4 is a control flowchart of a display device according to an embodiment of the disclosure;

FIG. 5 is an exemplary screen of a transparent display according to an embodiment of the disclosure;

FIGS. 6A to 6F are views for describing an operation of a display device considering a power generation time period, a remaining charge level of a battery, and/or whether an occupant is gazing at the display according to an embodiment of the disclosure;

FIG. 7 is a control flowchart of a display device according to an embodiment of the disclosure;

FIG. 8 is a control flowchart of a display device according to an embodiment of the disclosure;

FIG. 9 is a control flowchart of a display device according to an embodiment of the disclosure; and

FIG. 10 is a view illustrating a method of detecting a distance between a display device and an external person according to an embodiment of the disclosure.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

The terms as used herein are provided merely to describe some embodiments thereof, but are not intended to limit the technical features of the disclosure. As used herein, the singular forms “a,” “an,” and “the” are intended to include the plural forms as well, unless the context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, such terms as “1st” and “2nd,” or “first” and “second” may be used to simply distinguish a corresponding component from another, and does not limit the components in other aspect (e.g., importance or order).

When a (e.g., first) component is mentioned as “coupled to,” “connected to,” “supported by,” or “contacting” another (e.g., second) component with or without the terms “functionally” or “communicatively,” the component may be directly or indirectly coupled to, connected to, supported by, or contact the other component.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof. Throughout the specification, when one component is positioned “on” another component, the first component may be positioned directly on the second component, or other component(s) may be positioned between the first and second component.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

The terms “upper side”, “lower side”, and “front and rear directions” used in the disclosure are defined with respect to the drawings, and the shape and position of each component are not limited by these terms.

In the disclosure, the above-described description has been made of embodiments, but the disclosure is not limited to such embodiments, but should rather be appreciated as covering all various modifications, equivalents, and/or substitutes of various embodiments. With regard to the description of the drawings, similar reference numerals may be used to refer to similar or related elements.

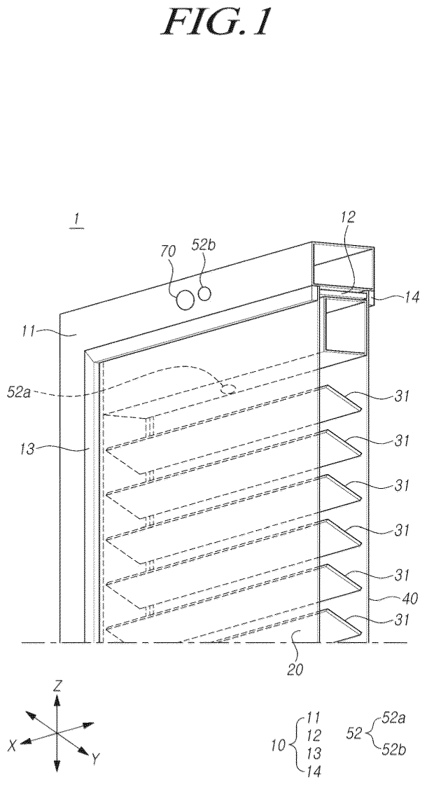

FIG. 1 is a partial cross-sectional perspective view illustrating a display device according to an embodiment of the disclosure.

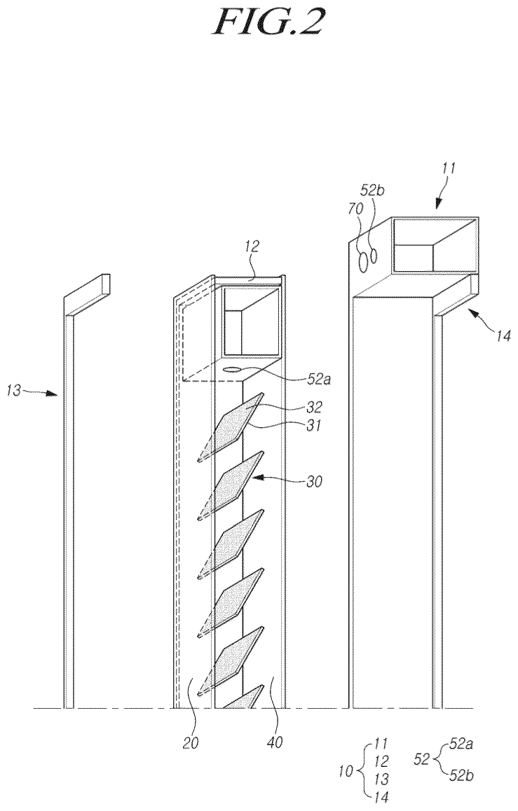

FIG. 2 is an exploded perspective view illustrating a partial configuration of a display device according to an embodiment of the disclosure.

Referring to FIGS. 1 and 2, a display device 1 according to an embodiment may include a housing 10, a glass panel 20, a blind device 30, and a transparent display 40.

According to an embodiment, the housing 10 may constitute an overall appearance or framework of the display device 1. The housing 10 may be configured to fix and/or support the glass panel 20, the blind device 30, and/or the transparent display 40 of the display device 1.

According to an embodiment, the housing 10 may include an outer frame 11, an inner frame 12, a front frame 13, and a rear frame 14.

According to an embodiment, the outer frame 11 may have a window shape with an opening formed inside.

According to an embodiment, the inner frame 12 may be provided inside the opening of the outer frame 11. The inner frame 12 may have a window shape with an opening formed inside, like the outer frame 11.

According to an embodiment, the front frame 13 may be coupled to a front edge of the inner frame 12. The front frame 13 may have a rectangular band shape to have a shape corresponding to the front edge of the inner frame 12. The front frame 13 may support the glass panel 20 from the front (e.g., +X-axis direction).

According to an embodiment, the rear frame 14 may be coupled to a rear edge of the inner frame 12. The rear frame 14 may have a rectangular band shape to have a shape corresponding to the rear edge of the inner frame 12. The rear frame 14 may support the transparent display 40 from the rear (e.g., −X-axis direction).

According to an embodiment, the glass panel 20 may be disposed to face outside of the display device 1. For example, the glass panel 20 may be disposed adjacent to an outdoor space. At least a portion of the glass panel 20 may be disposed between the front frame 13 and the inner frame 12. For example, an edge portion of the glass panel 20 may be disposed between the front frame 13 and the inner frame 12. The glass panel 20 may be formed of a transparent glass material.

According to an embodiment, the blind device 30 may be configured to manage the amount of heat and light flowing into the room by controlling natural light from the outside by opening and closing an indoor space from the outside. For example, the blind device 30 may control the light entering the indoor space through a gap formed between slits 31 by adjusting the rotation angle of one or more slits 31. Further, the blind device 30 may be configured to generate electrical energy using solar light through a solar panel 32 to be described below.

According to an embodiment, the blind device 30 may include one or more slits 31 and one or more solar panels 32.

According to an embodiment, the one or more slits 31 may be rotatably disposed inside (or opening) the inner frame 12. For example, the slit 31 may rotate with different rotation angles following the solar altitude for solar charging. Each of the plurality of slits 31 may be disposed to be spaced apart from each other in a vertical direction (e.g., ±Z-axis direction). By rotation of the one or more slits 31, at least a portion of the transparent display 40 disposed behind may be covered or exposed to the outside. One or more slits 31 may be understood as a physical component of the blind device 30 having a board shape, as illustrated in the drawing. For example, one or more slits 31 may block the indoor space from the outside by at least partially covering the transparent display 40 adjacent to the blind device 30 from the front through rotation. Here, the slit 31 may be used interchangeably with or referred to as a ‘slat’ in the present specification and claims, and they refer to substantially the same object.

According to an embodiment, the one or more solar panels 32 may be disposed on a surface of the corresponding slit 31. The solar panel 32 may be a device that converts solar energy into electrical energy. The electrical energy converted by the solar panel 32 may be stored in a battery 33 to be described below and may be used for driving the slit 31 and/or the transparent display 40. The solar panel 32 may be implemented as, e.g., a crystalline silicon-based, amorphous silicon-based (a-Si), copper indium selenium-based (CIS), copper indium gallium selenium-based (CIGS), cadmium telluride-based (CdTe), dye-sensitized, or perovskite solar panel, but the disclosure is not limited thereto.

According to an embodiment, the transparent display 40 may be disposed to face inside of the display device 1. For example, the transparent display 40 may be disposed adjacent to an indoor space. At least a portion of the transparent display 40 may be disposed between the inner frame 12 and the rear frame 14. For example, an edge portion of the transparent display 40 may be disposed between the inner frame 12 and the rear frame 14.

According to an embodiment, the transparent display 40 may have a display screen implemented transparently. The transparent display 40 may output information (or content) on the transparent screen. A user may look at a background (e.g., an outdoor scenery) beyond the transparent screen of the transparent display 40. For example, the transparent display 40 may be configured based on an organic light emitting diode (OLED) or micro light emitting diode (LED). The transparent display 40 may change in transparency as the luminance of the display is adjusted. For example, in case that the luminance of the transparent display 40 increases, the screen of the transparent display 40 becomes opaque and, in case that the luminance of the transparent display 40 decreases, the screen of the transparent display 40 may become transparent.

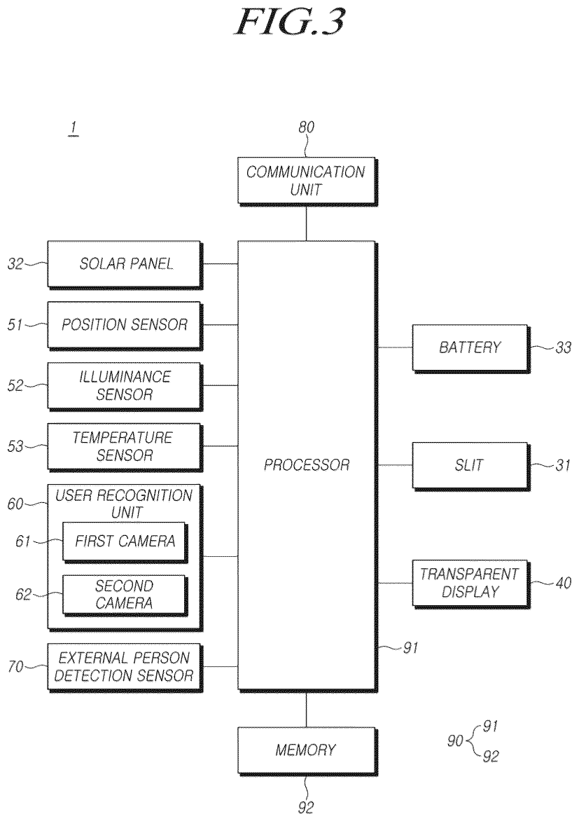

FIG. 3 is a control block diagram illustrating a display device according to an embodiment of the disclosure.

Referring to FIG. 3, a display device 1 according to an embodiment may include a solar panel 32, a position sensor 51, one or more illuminance sensors 52, a temperature sensor 53, a user recognition unit 60, an external person detection sensor 70, a communication unit or communication interface 80, a controller 90, a battery 33, one or more slits 31, and a transparent display 40.

According to an embodiment, the position sensor 51 may be configured to obtain position information about a place where the display device 1 is installed. For example, the position sensor 51 may be implemented based on a global positioning system (GPS).

According to an embodiment, the one or more illuminance sensors 52 may be configured to detect ambient illuminance around the display device 1. The illuminance sensor 52 may include a first illuminance sensor 52a for detecting illuminance of an indoor space and a second illuminance sensor 52b for detecting illuminance of an outdoor space. The first illuminance sensor 52a may be provided at a position for detecting movement of the slit 31 and/or the solar panel 32. For example, the first illuminance sensor 52a may be disposed on a lower surface of an upper portion of the inner frame 12, as illustrated in FIG. 2. The second illuminance sensor 52b may be disposed on a front edge of the outer frame 11. The first illuminance sensor 52a may be referred to as an indoor illuminance sensor, and the second illuminance sensor 52b may be referred to as an outdoor illuminance sensor.

According to an embodiment, the temperature sensor 53 may be configured to detect an indoor-side temperature of the display device 1. For example, the blind device 30 may be driven to block the indoor space from the outside according to a temperature value measured by the temperature sensor 53.

According to an embodiment, the user recognition unit 60 may be a component for detecting presence or absence of an occupant in the indoor space or for tracking movement (or gaze) of the occupant. The user recognition unit 60 may include a first camera 61 and a second camera 62. The first camera 61 may detect presence or absence of an occupant in the indoor space by detecting a distance between the display device 1 and the occupant positioned in the indoor space. The first camera 61 may be implemented as a depth camera. The second camera 62 may detect whether the occupant is looking at the transparent display 40 by tracking movement or gaze) of the occupant. The second camera 62 may be implemented as an infrared (IR) camera.

According to an embodiment, the external person detection sensor 70 may be configured to detect whether an external person (e.g., a pedestrian) is adjacent to the display device 1. For example, the external person detection sensor 70 may detect a distance between the display device 1 and the external person positioned in the outdoor space. The external person detection sensor 70 may be implemented as a depth camera, like the first camera 61 described above. The external person detection sensor 70 may be provided on a front edge of the outer frame 11, as illustrated in FIG. 2.

According to an embodiment, the communication unit 80 may receive and/or transmit a wired/wireless signal to/from an external wired/wireless communication system, an external server, and/or other devices according to a predetermined wired/wireless communication protocol. In an example, the communication unit 80 may include one or more modules to connect the display device 1 to one or more networks. In an example, the communication unit 80 may include at least one of a mobile communication module, a wired/wireless Internet module, a short-range communication module, and/or a location information module.

According to an embodiment, the mobile communication module may transmit/receive wireless signals with at least one of an external base station, an external UE, and an external server through the mobile communication network according to any communication protocol among various communication protocols for mobile communication. The wireless signals may include various types of data signals. In an example, the wireless signal may include a voice call signal, a video call signal, and a text/multimedia message signal, and the disclosure is not limited thereto.

According to an embodiment, the wired/wireless Internet module may support wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), or long term evolution-advanced (LTE-A), but is not limited thereto. In an example, the wired/wireless Internet module of the communication unit 80 may transmit/receive data according to at least one wired/wireless Internet technology among Internet technologies not listed above.

According to an embodiment, the short-range communication module may be intended for, e.g., short-range communication and may support short-range communication using at least one of Bluetooth, radio frequency identification (RFID), infrared data association (IrDA), ultra-wideband (UWB), ZigBee, near-field communication (NFC), Wi-Fi, Wi-Fi Direct, or wireless universal serial bus (USB) technology. The short-range communication module may support, e.g., wireless communication between the display device 1 and a wireless communication system, between the display device 1 and another device, or between the display device 1 and a network in which the other device is positioned through a short-range wireless communication network.

According to an embodiment, the location information module may be, e.g., a global positioning system (GPS) module or a Wi-Fi module as a module for obtaining the location of the display device 1. In case that the display device 1 utilizes the GPS module, the display device 1 may receive information about the location of the display device 1 using a signal transmitted from the GPS satellite. In case that the display device 1 utilizes the Wi-Fi module, the display device 1 may receive information about the location of the display device 1 based on information about a wireless access point (AP) that transmits and receives a wireless signal to and from the Wi-Fi module. The position information module may be replaced by the position sensor 51 described above.

According to an embodiment, the communication unit 80 may receive the configuration data signal input by the user on the mobile terminal of the user in the form of a wireless signal according to a predetermined wireless communication protocol. In an example, the communication unit 80 may receive information and/or a command for controlling the operation of the display device 1 from an external server in the form of a signal according to a predetermined wired/wireless communication protocol. The communication unit 80 may transfer various received signals to the controller 90. In an example, the communication unit 80 may transmit various data generated or obtained on the display device 1 in the form of a wired/wireless signal according to a predetermined wired/wireless communication protocol, e.g., to a mobile terminal of the user or an external server.

According to an embodiment, the controller 90 may be a component for controlling the overall operation of the display device 1. The controller 90 may include a memory 92 for storing or recording a program and/or data for controlling each component of the display device 1, and a processor 91 for generating a control signal for controlling each component of the display device 1 according to the program and/or data stored in the memory 92 and information obtained from each of the other components.

According to an embodiment, the memory 92 may store various data that may be used to control the operation of each component of the display device 1. The memory 92 may store, e.g., the plurality of application programs used in the display device 1, data for controlling the operation of the display device 1, and instructions. At least some of the application programs stored in the memory 92 may be downloaded from an external server through wireless communication. At least some of the application programs stored in the memory 92 may be stored in the memory 92 from the time of shipment for default functions of the display device 1.

According to an embodiment, data regarding a display mode of the display device 1 may be stored in the memory 92. For example, the rotation angle of the slit 31 for each power generation time period may be stored in the memory 92. For example, information regarding the remaining charge level of the battery 33 may be stored in the memory 92. For example, information regarding the limit temperature of the indoor space may be stored in the memory 92.

According to an embodiment, the processor 91 may receive weather information or other various control information according to the installation position of the display device 1 from the communication unit 80.

According to an embodiment, the processor 91 may obtain sensing information from the sensors 51, 52, 53, 60, 70. For example, the processor 91 may obtain position information about an installation place of the display device 1 from the position sensor 51. For example, the processor 91 may obtain information about ambient illuminance of the display device 1 from the illuminance sensor 52. For example, the processor 91 may obtain information about ambient temperature (e.g., indoor space) of the display device 1 from the temperature sensor 53. For example, the processor 91 may obtain information about a distance between the display device 1 and an occupant from the first camera 61. For example, the processor 91 may obtain information about movement (or gaze) of the occupant from the second camera 62. For example, the processor 91 may obtain information about a distance between the display device 1 and an external person (or pedestrian) from the external person detection sensor 70.

According to an embodiment, the processor 91 may generate operation control commands for each component of the display device 1 based on various information received from the communication unit 80 and/or the sensors 51, 52, 53, 60, 70. In an example, the processor 91 may adjust the rotation angle of the slit 31 based on weather information. In an example, the processor 91 may adjust the luminance of the transparent display 40 corresponding to the rotation angle of the slit 31.

According to an embodiment, the processor 91 may generate a command to control whether and how to display information through the transparent display 40 based on various information received from the communication unit 80 and/or the sensors 51, 52, 53, 60, 70.

According to an embodiment, the controller 90 is disclosed as one comprehensive configuration that controls all components included in the display device 1, but the disclosure is not limited thereto. In an example, the display device 1 may be configured to include a plurality of controller configurations that individually control some of the components of the display device 1. In an example, the display device 1 may include a separate controller having a processor and memory for controlling operation of the blind device 30, such as a driving motor (not illustrated). In an example, the display device 1 may include a separate controller having a processor and memory for controlling operation of a user interface according to a user input. The processor 91 of the controller 90 may include a plurality of processors, and the memory 92 may include a plurality of memory devices.

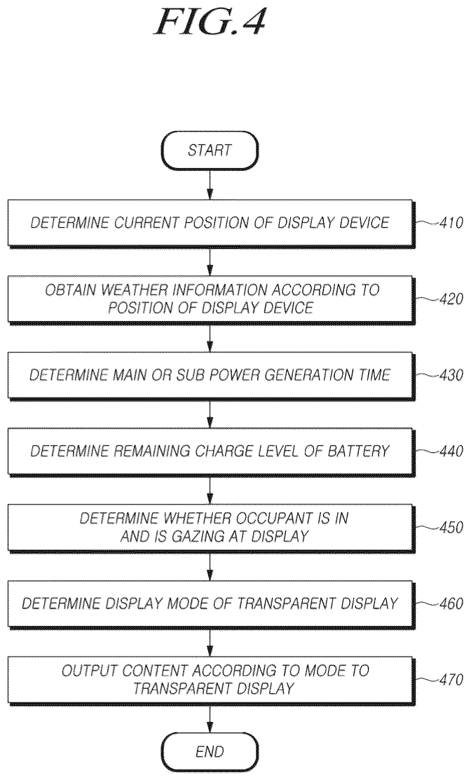

FIG. 4 is a control flowchart of a display device according to an embodiment of the disclosure.

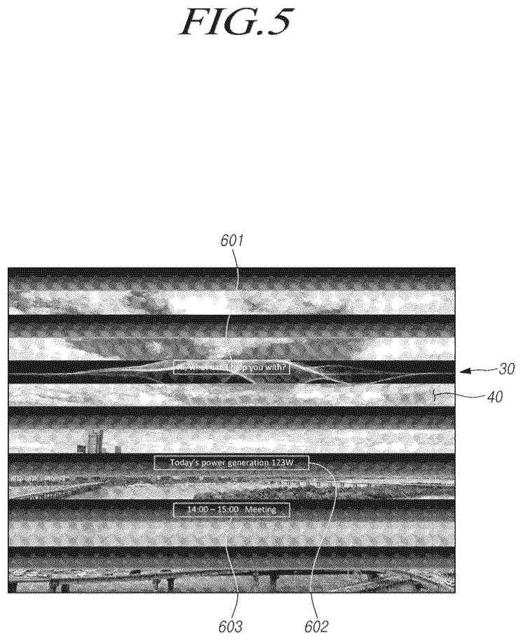

FIG. 5 is an exemplary screen of a transparent display according to an embodiment of the disclosure.

Referring to FIG. 4, a display device 1 according to an embodiment may obtain information about a current position of the display device 1 from a position sensor 51 in operation 410. The information about the current position of the display device 1 may include information about an installation position (region) and/or installation direction of the display device 1.

According to an embodiment, the display device 1 may transmit the information about the current position of the display device 1 obtained in operation 410 to a weather server (e.g., a server) and obtain weather information corresponding to the current position of the display device 1 from the weather server in operation 420. The weather information may include, e.g., solar altitude, illuminance values by time period, and/or weather information at the current position of the display device 1.

According to an embodiment, the display device 1 may classify the power generation time period of the display device 1 based on the weather information corresponding to the current position of the obtained display device 1 in operation 430. For example, the display device 1 may classify the power generation time period of the display device 1 into a main power generation time or a sub power generation time based on the obtained weather information. The main power generation time and the sub power generation time may be set considering the installation direction of the display device 1. This is because the power generation amount of the display device 1 may vary according to the installation direction of the display device 1 with respect to the altitude change path of the sun. For example, in case that the display device 1 is installed facing east, the main power generation time of the display device 1 may correspond to a morning time period, and the sub power generation time may correspond to the remaining time period in case that the sun is up except for the main power generation time. For example, in case that the display device 1 is installed facing south, the main power generation time period of the display device 1 may correspond to a time period adjacent to noon, and the sub power generation time may correspond to the remaining time period in case that the sun is up except for the main power generation time. For example, in case that the display device 1 is installed facing west, it may correspond to an afternoon time period, and the sub power generation time may correspond to the remaining time period in case that the sun is up except for the main power generation time. The power generation amount in the main power generation time period of the display device 1 may be higher than the power generation amount in the sub power generation time.

According to an embodiment, the display device 1 may rotate the slit 31 at different rotation angles according to the power generation time period. Further, the display device 1 may adjust the luminance of the transparent display 40 corresponding to the rotation angle of the slit 31.

According to an embodiment, the display device 1 may monitor the remaining charge level of the battery 33 in operation 440. In an embodiment, the display device 1 may differently adjust the rotation angle of the slit 31 according to the monitored remaining charge level of the battery 33 in the sub power generation time period.

According to an embodiment, the display device 1 may detect presence or absence of an occupant in the indoor space or determine (e.g., identify) whether the occupant is gazing at the display through cameras 61, 62 of the user recognition unit 60 in operation 450. For example, the display device 1 may detect presence or absence of an occupant in the indoor space by detecting a distance between the display device 1 and the occupant through the first camera 61 of the user recognition unit 60. For example, the display device 1 may track the gaze and/or head movement of the occupant through the second camera 62 of the user recognition unit 60 and determine whether the occupant is gazing at the display 40 based thereon.

According to an embodiment, the display device 1 may determine a display mode of the transparent display 40 based on whether the occupant is gazing at the display 40 in operation 460. For example, the display device 1 may vary the type of content output on the transparent display 40 according to whether the occupant is gazing at the display 40. The content may include user content by a user input (or request) and/or advertising content received from an external device (e.g., an advertisement server). In this case, at least some of the content output on the transparent display 40 may be output at a position corresponding to the slit 31. For example, as illustrated in FIG. 5, in the case of bar-type notifications 601, 602, 603, they may be output at a position facing the slit 31 to secure visibility.

According to an embodiment, the display device 1 may output content corresponding to the display mode of the transparent display 40 determined in operation 460 on the transparent display 40 in operation 470.

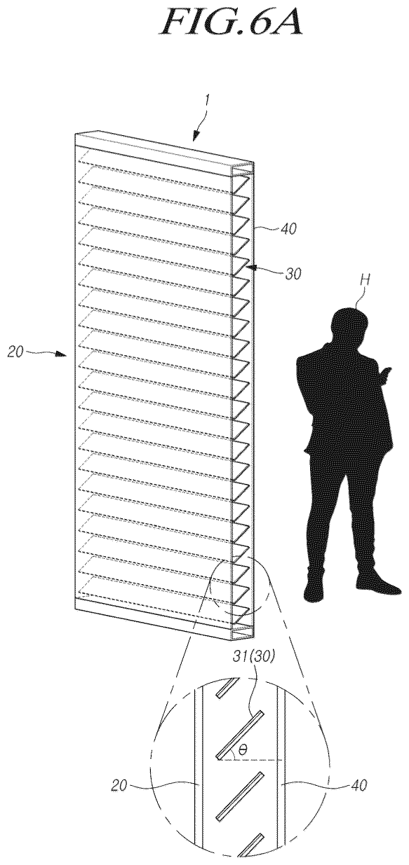

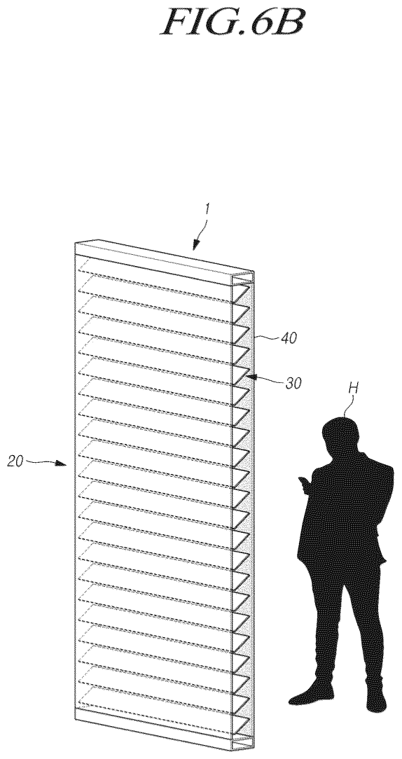

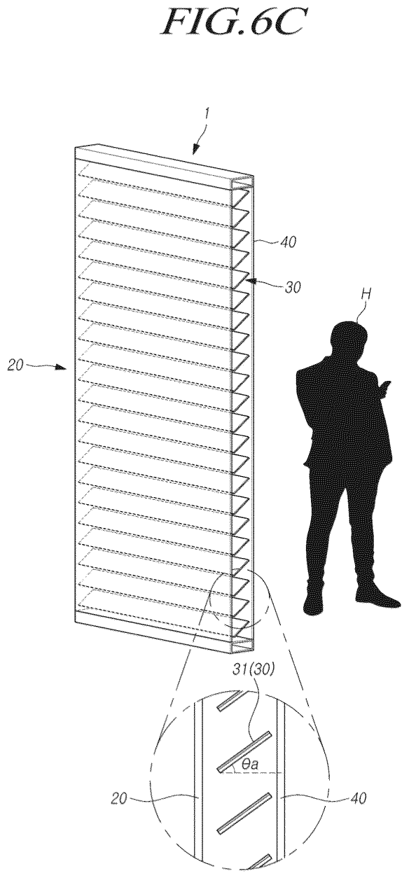

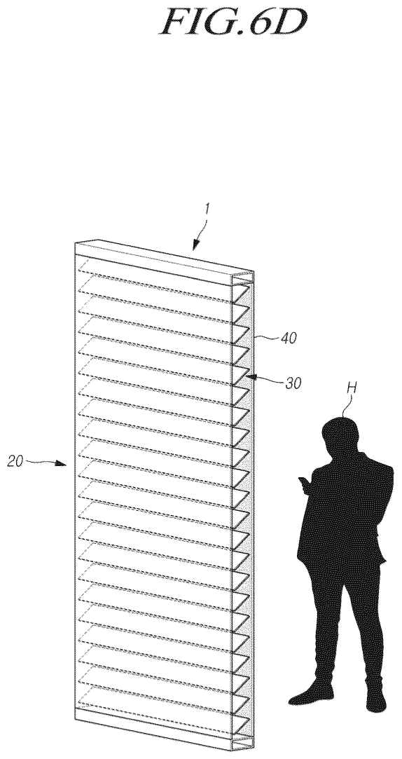

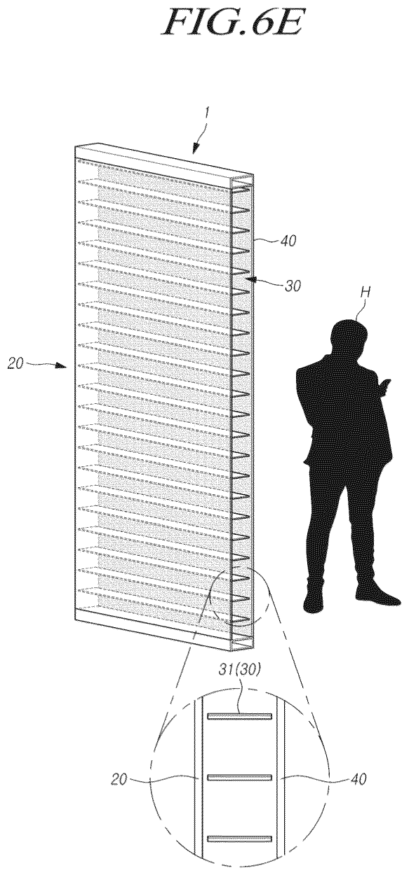

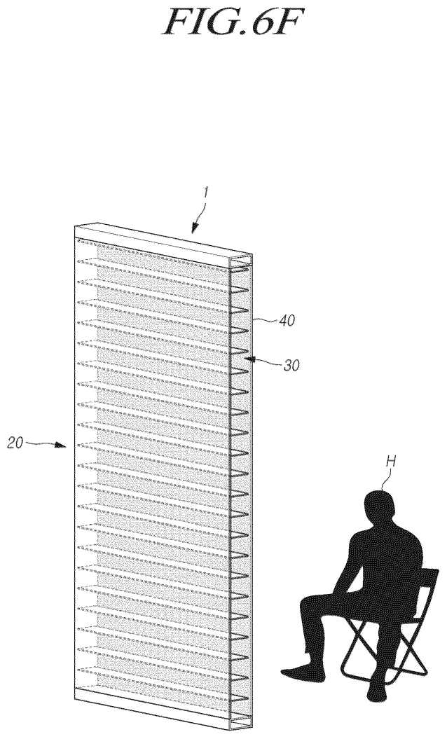

FIGS. 6A to 6F are views for describing an operation of a display device considering a power generation time period, a remaining charge level of a battery, and/or whether an occupant is gazing at the display according to an embodiment of the disclosure.

FIGS. 6A and 6B are views illustrating an operation of the display device 1 according to whether an occupant H is gazing at the display 40 during the main power generation time period.

Referring to FIGS. 6A and 6B, a display device 1 according to an embodiment may change the rotation angle θ of the slit 31 in real-time corresponding to the solar altitude that changes in real-time during the main power generation time period. The rotation angle θ of the slit 31 may be defined as an angle between the slit 31 and the ground.

According to an embodiment, the display device 1 may differently adjust the content screen output and/or the luminance of the display 40 based on presence or absence of gazing at the display 40 by the occupant H during the main power generation time period.

For example, as illustrated in FIG. 6A, in case that the occupant H is not gazing at the display 40, the display device 1 may adjust the luminance of the display 40 to below a set luminance (e.g., about 30%). In an embodiment, in case that the occupant H is not gazing at the display 40, the display device 1 may adjust the luminance of the display 40 in inverse proportion to the rotation angle θ of the slit 31 within a range below the set luminance. For example, as the rotation angle θ of the slit 31 decreases, the amount of light transmitted toward the display 40 increases, so the luminance of the display 40 may be enhanced to secure visibility of the display 40. Further, although not specified in this drawing, in case that the occupant H is not gazing at the display 40, the display device 1 may output content such as a background screen on the display 40 for privacy protection.

For example, as illustrated in FIG. 6B, in case that the occupant H is gazing at the display 40, the display device 1 may adjust the luminance of the display 40 to above the set luminance (e.g., about 30%). In this case, content according to user request may be output on the display 40, and the luminance of the display 40 may vary according to a user input (or request). Alternatively, the luminance of the display 40 may be adjusted in inverse proportion to the rotation angle θ of the slit 31 to secure visibility of the display 40.

In FIGS. 6C to 6F, the display device 1 according to an embodiment may fix the rotation angle of the slit 31 at different angles according to the degree of remaining charge level of the battery 33 during the sub power generation time period.

Referring to FIGS. 6C and 6D, the display device 1 according to an embodiment may rotate and/or fix the rotation angle of the slit 31 to a first fixed angle θa in case that the remaining charge level of the battery 33 is low during the sub power generation time period. The first fixed angle θa may be set considering the installation position and/or installation direction of the display device 1. For example, the first fixed angle θa may be a value considering seasonal solar efficiency according to the installation position and/or installation direction of the display device 1. For example, the first fixed angle θa may be set to about 40 degrees based on Seoul.

According to an embodiment, in case that the remaining charge level of the battery 33 is low, the display device 1 may differently adjust the content screen output and/or the luminance of the display 40 based on presence or absence of gazing at the display 40 by the occupant H.

For example, as illustrated in FIG. 6C, in case that the remaining charge level of the battery 33 is low and the occupant H is not gazing at the display 40, the display device 1 may adjust the luminance of the display 40 to below the set luminance (e.g., about 30%). Further, although not specified in this drawing, in case that the occupant H is not gazing at the display 40, the display device 1 may output content such as a background screen on the display 40 for privacy protection.

For example, as illustrated in FIG. 6D, in case that the remaining charge level of the battery 33 is low and the occupant H is gazing at the display 40, the display device 1 may adjust the luminance of the display 40 to above the set luminance (e.g., about 30%). In this case, content according to user request may be output on the display 40, and the luminance of the display 40 may vary according to a user input (or request).

Referring to FIGS. 6E and 6F, the display device 1 according to an embodiment may rotate the slit 31 to a second fixed angle in case that the remaining charge level of the battery 33 is high during the sub power generation time period. The second fixed angle may be set to about 0 degrees as an angle where the slit 31 is disposed substantially parallel to the ground.

According to an embodiment, in case that the remaining charge level of the battery 33 is high, the display device 1 may differently adjust the content screen output based on presence or absence of gazing at the display 40 by the occupant.

For example, as illustrated in FIG. 6E, in case that the remaining charge level of the battery 33 is high and the occupant H is not gazing at the display 40, the display device 1 may perform a function like a billboard by outputting advertising content on the display 40.

For example, as illustrated in FIG. 6F, in case that the remaining charge level of the battery 33 is high and the occupant H is gazing at the display 40, the display device 1 may adjust the luminance of the display 40 to above the set luminance (e.g., about 30%). In this case, content according to user request may be output on the display 40, and the luminance of the display 40 may vary according to a user input (or request).

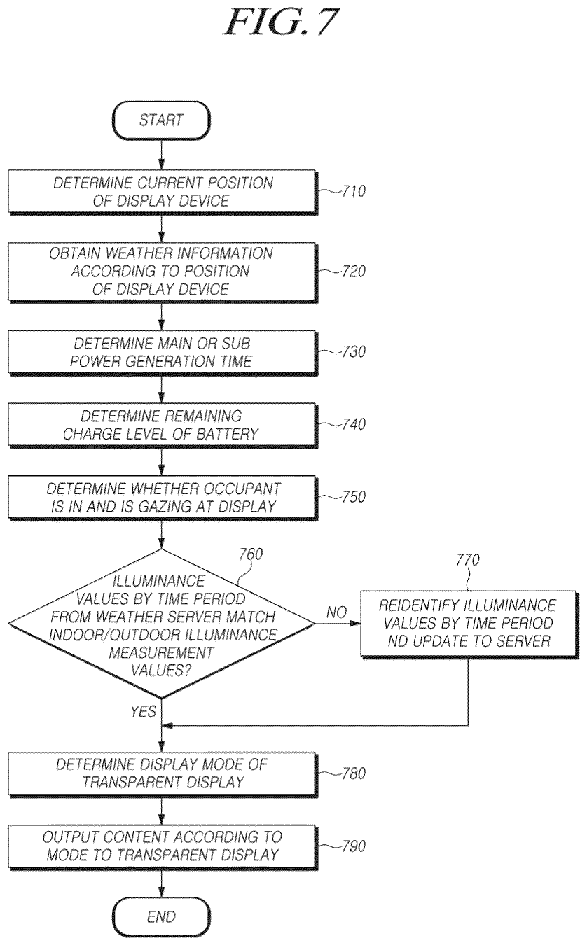

FIG. 7 is a control flowchart of a display device according to an embodiment of the disclosure.

The embodiment of FIG. 7 may be selectively combined with the embodiment of FIG. 4.

Operations 710, 720, 730, 740, 750, 780, 790 of FIG. 7 substantially correspond to operations 410, 420, 430, 440, 450, 460, 470 of FIG. 4 described above, so descriptions thereof are omitted for convenience of description.

Referring to FIG. 7, the display device 1 according to an embodiment may obtain information about ambient illuminance of the display device 1 from an illuminance sensor 52 in operation 760. According to an embodiment, the display device 1 may compare the illuminance values by time period received from the weather server with the illuminance measurement values obtained from the illuminance sensor 52 to determine whether they match each other in operation 760.

According to an embodiment, the display device 1 may reidentify the illuminance values by time period from the weather server and update the illuminance measurement values obtained from the illuminance sensor 52 to the weather server in case that the comparison results of the illuminance values by time period received from the weather server and the illuminance measurement values obtained from the illuminance sensor 52 do not match in operation 770. The display device 1 may provide a more accurate display environment by reflecting and/or updating in case that changes in illuminance values by time period occur due to the external environment of the display device 1. For example, in case that changes in illuminance values by time period occur due to the external environment of the display device 1, the luminance of the display 40 may be adjusted corresponding to the changed illuminance values.

According to an embodiment, the display device 1 may adjust content and/or luminance according to the display mode of the display 40 as described above in case that the comparison results of the illuminance values by time period received from the weather server and the illuminance measurement values obtained from the illuminance sensor 52 match in operation 780.

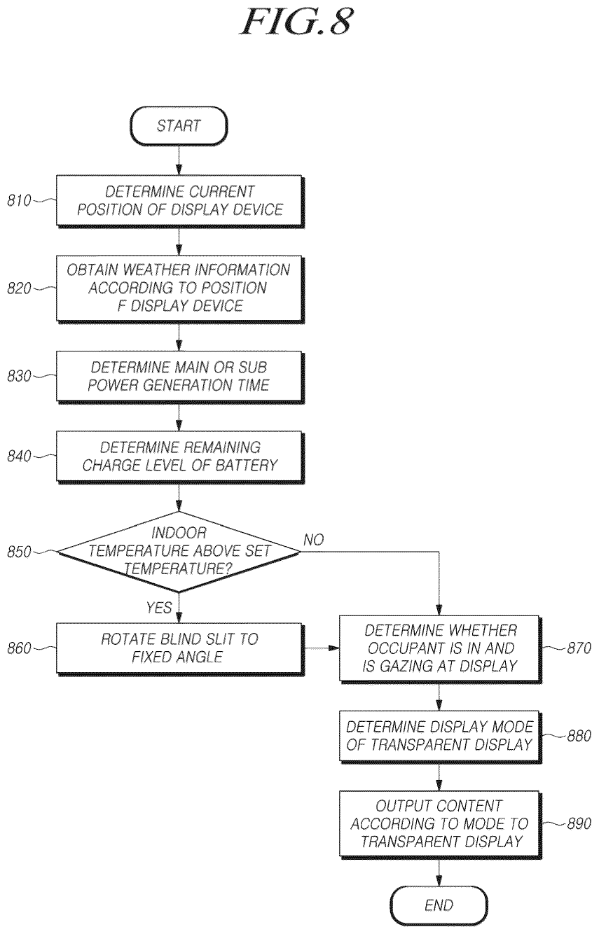

FIG. 8 is a control flowchart of a display device according to an embodiment of the disclosure.

The embodiment of FIG. 8 may be selectively combined with the embodiment of FIG. 4 or FIG. 7.

Operations 810, 820, 830, 840, 870, 880, 890 of FIG. 8 substantially correspond to operations 410, 420, 430, 440, 450, 460, 470 of FIG. 4 described above, so descriptions thereof are omitted for convenience of description.

Referring to FIG. 8, the display device 1 according to an embodiment may determine whether the indoor temperature detected by the temperature sensor 53 is above a set temperature in operation 850. The set temperature may be set to about 33 degrees, e.g., considering the body temperature of a worker in the indoor space.

According to an embodiment, the display device 1 may rotate the slit 31 to a third fixed angle in case that the indoor temperature detected by the temperature sensor 53 is above the set temperature in operation 860. The third fixed angle may be, e.g., an angle perpendicular to the ground, about 90 degrees. In case that the slit 31 rotates to the third fixed angle, substantially the entire surface of the transparent display 40 is covered by the slit 31, and accordingly, as natural light toward the transparent display 40 is blocked, temperature rise in the indoor space may be decreased.

According to an embodiment, the display device 1 may detect presence or absence of an occupant in the indoor space or determine whether the occupant is gazing at the display through cameras 61, 62 of the user recognition unit 60 in case that the indoor temperature detected by the temperature sensor 53 is below the set temperature or in case that rotation of the slit 31 to the third fixed angle is completed in operation 870.

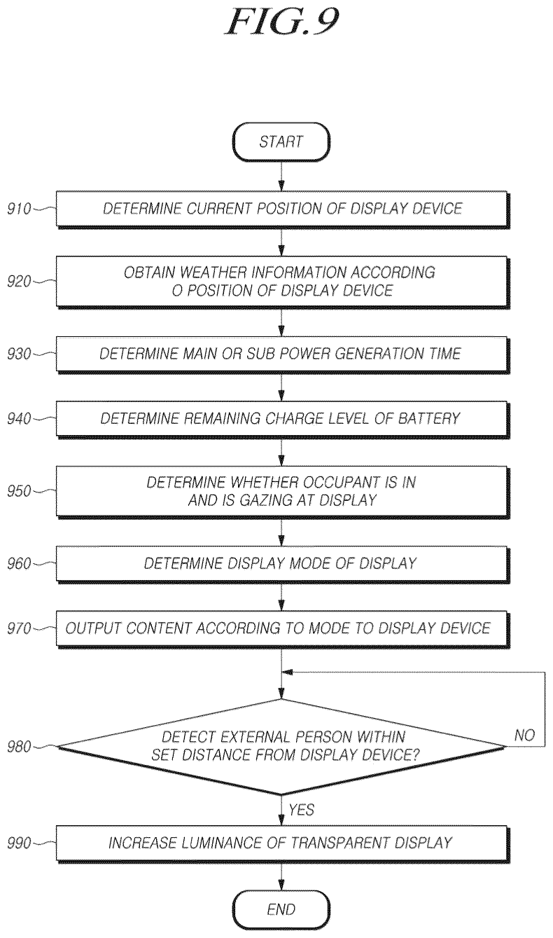

FIG. 9 is a control flowchart of a display device according to an embodiment of the disclosure.

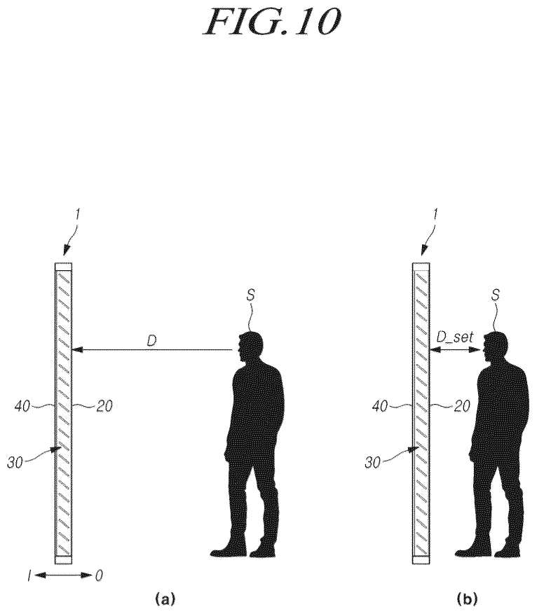

FIG. 10 is a view illustrating a method of detecting a distance between a display device and an external person according to an embodiment of the disclosure.

The embodiment of FIG. 9 may be selectively combined with the embodiment of FIG. 4.

Operations 910, 920, 930, 940, 950, 960, 970 of FIG. 9 substantially correspond to operations 410, 420, 430, 440, 450, 460, 470 of FIG. 4 described above, so descriptions thereof are omitted for convenience of description.

Referring to FIGS. 9 and 10, the display device 1 according to an embodiment may measure a distance D between the display device 1 and an external person S through an external person detection sensor 70 in operation 980. According to an embodiment, the display device 1 may determine whether the measured distance D between the display device 1 and the external person S is within a set distance D_set in operation 980. The set distance D_set may be set to, e.g., about 30 cm, but the disclosure is not limited thereto.

According to an embodiment, the display device 1 may increase the luminance of content currently being output on the display 40 in case that the external person S is positioned within the set distance D_set in operation 990. For example, the display device 1 may adjust the luminance of the display 40 to above the set luminance (e.g., about 50%) in case that the external person S is positioned within the set distance D_set. As the luminance of the display 40 increases, the display 40 becomes opaque, thereby blocking the gaze of the external person S into the indoor space.

A display device 1 capable of solar charging according to an embodiment of the disclosure may include a blind device 30 including one or more rotatable slits 31 and having a solar panel 32 provided on one surface thereof, a transparent display 40 disposed behind the blind device 30, and a processor 91 for controlling (e.g., configured to control) the blind device 30 and the transparent display 40. The processor 91 may be configured to determine whether a current power generation time period is a main power generation time or a sub power generation time based on an installation position of the display device 1, adjust a rotation angle of the slit 31 based on the determined power generation time period, and adjust a luminance of the transparent display 40 based on the rotation angle of the slit 31.

According to an embodiment, the display device 1 may further include a communication unit or communication interface 80 for communication with a weather server. The processor 91 may be configured to receive weather information according to the installation position of the display device 1 from the weather server, wherein the weather information includes solar altitude, and adjust the rotation angle of the slit 31 according to the solar altitude during the main power generation time.

According to an embodiment, the display device 1 may include one or more cameras 61, 62 for tracking a gaze of an occupant. The processor 91 may be configured to determine whether the occupant is gazing at the transparent display 40 through the cameras 61, 62, adjust the luminance of the transparent display 40 to below a set luminance in case that the occupant is not gazing (e.g., based on the occupant not gazing) at the transparent display 40 during the main power generation time, and adjust the luminance of the transparent display 40 to above the set luminance in case that the occupant is gazing (e.g., based on the occupant gazing) at the transparent display 40.

According to an embodiment, the processor 91 may be configured to adjust the luminance of the transparent display 40 in inverse proportion to the rotation angle of the slit 31 within a range below the set luminance in case that the occupant is not gazing at the transparent display 40.

According to an embodiment, the display device 1 may include a battery 33 electrically connected to the solar panel 32 and configured to store power generated by the solar light. The processor 91 may be configured to adjust the rotation angle of the slit 31 to a predetermined fixed angle according to a charge level of the battery 33 during the sub power generation time.

According to an embodiment, the processor 91 may be configured to rotate the slit 31 to a first fixed angle in case that the charge level of the battery 33 is below a set charge level, and rotate the slit 31 to a second fixed angle in case that the charge level of the battery 33 is above the set charge level. The first fixed angle may be greater than the second fixed angle.

According to an embodiment, the first fixed angle may be determined considering an installation direction of the display device 1.

According to an embodiment, the display device 1 may include one or more cameras 61, 62 for tracking (e.g., configured to track) a gaze of an occupant. The processor 91 may be configured to determine whether the occupant is gazing at the transparent display 40 through the cameras 61, 62, and during rotation of the slit 31 to the first fixed angle, adjust the luminance of the transparent display 40 to below a set luminance in case that the occupant is not gazing at the transparent display 40, and adjust the luminance of the transparent display 40 to above the set luminance in case that the occupant is gazing at the transparent display 40.

According to an embodiment, the display device 1 may include one or more cameras 61, 62 for tracking a gaze of an occupant. The processor 91 may be configured to determine whether the occupant is gazing at the transparent display 40 through the cameras 61, 62, and during rotation of the slit 31 to the second fixed angle, output advertising content on the transparent display 40 in case that the occupant is not gazing at the transparent display 40, and output content according to a user request on the transparent display 40 in case that the occupant is gazing at the transparent display 40.

According to an embodiment, the display device 1 may include a communication unit or communication interface 80 for communication with a weather server and one or more illuminance sensors 52 for detecting (e.g., configured to detect) an ambient illuminance around the display device 1. The processor 91 may be configured to receive weather information according to the installation position of the display device 1, wherein the weather information includes illuminance values by time period, and adjust the luminance of the transparent display by comparing a current illuminance detected by the illuminance sensor 52 with illuminance values received from the weather server.

According to an embodiment, the one or more illuminance sensors 52 may include a first illuminance sensor 52a disposed to face the one or more slits 31, and a second illuminance sensor 52b disposed to face outside of the display device 1.

According to an embodiment, the display device 1 may include a camera 70 for detecting an external person adjacent to the display device 1. The processor 91 may be configured to adjust the luminance of the transparent display 40 to above a second set luminance in case that a distance between the display device 1 and the external person obtained from the camera 70 is below a set distance.

According to an embodiment, the display device 1 may include a temperature sensor 53 for detecting an ambient temperature around the display device 1. The processor 91 may be configured to rotate the slit 31 to a third fixed angle in case that a current temperature detected from the temperature sensor 53 is above a set temperature.

In a method for controlling a display device 1 capable of solar charging according to an embodiment of the disclosure, the display device 1 may include a blind device 30 including one or more rotatable slits 31 and having a solar panel 32 provided on one surface thereof, and a transparent display 40 disposed behind the blind device 30. The method for controlling the display device 1 may include determining whether a current power generation time period is a main power generation time or a sub power generation time based on an installation position of the display device 1, adjusting a rotation angle of the slit 31 based on the determined power generation time period, and adjusting the luminance of the transparent display 40 based on the rotation angle of the slit 31.

According to an embodiment, the method for controlling the display device 1 may include receiving weather information according to the installation position of the display device 1 from a weather server, wherein the weather information includes solar altitude, and adjusting the rotation angle of the slit 31 according to the solar altitude during the main power generation time. By adjusting the rotation angle of the slit 31 according to the solar altitude, privacy protection and performance of the display is improved.

According to an embodiment, the display device 1 may include one or more cameras 61, 62 for tracking a gaze of an occupant. The method for controlling the display device 1 may include determining whether the occupant is gazing at the transparent display 40 through the cameras 61, 62, and during the main power generation time, adjusting the luminance of the transparent display 40 to below a set luminance in case that the occupant is not gazing at the transparent display 40, and adjusting the luminance of the transparent display 40 to above the set luminance in case that the occupant is gazing at the transparent display 40.

According to an embodiment, the method for controlling the display device 1 may include adjusting the luminance of the transparent display 40 in inverse proportion to the rotation angle of the slit 31 within a range below the set luminance in case that the occupant is not gazing at the transparent display 40.

According to an embodiment, the display device 1 may include a battery 33 electrically connected to the solar panel 32 and configured to store power generated by the solar light. The method for controlling the display device 1 may include adjusting the rotation angle of the slit 31 to a predetermined fixed angle according to a charge level of the battery 33 during the sub power generation time.

According to an embodiment, the method for controlling the display device 1 may include rotating the slit 31 to a first fixed angle in case that the charge level of the battery 33 is below a set charge level, and rotating the slit 31 to a second fixed angle in case that the charge level of the battery 33 is above the set charge level. The first fixed angle may be greater than the second fixed angle.

According to an embodiment, the display device 1 may include one or more cameras 61, 62 for tracking a gaze of an occupant. The method for controlling the display device 1 may include determining whether the occupant is gazing at the transparent display 40 through the cameras 61, 62, and during rotation of the slit 31 to the first fixed angle, adjusting the luminance of the transparent display 40 to below a set luminance in case that the occupant is not gazing at the transparent display 40, and adjusting the luminance of the transparent display 40 to above the set luminance in case that the occupant is gazing at the transparent display 40.

According to an embodiment, the display device 1 may include one or more cameras 61, 62 for tracking a gaze of an occupant. The method for controlling the display device 1 may include, during rotation of the slit 31 to the second fixed angle, outputting advertising content on the transparent display 40 in case that the occupant is not gazing at the transparent display 40, and outputting content according to user request on the transparent display 40 in case that the occupant is gazing at the transparent display 40.

What is claimed is:

1. A display device comprising:
a blind device comprising one or more rotatable slits and one or more solar panels on a surface of the corresponding slit;
a transparent display provided behind the blind device;
memory storing one or more instructions; and
at least one processor configured to control the blind device and the transparent display, wherein the one or more instructions, when individually or collectively executed by the at least one processor, cause the display device to:
identify a power generation time period as a main power generation time or a sub power generation time based on an installation position of the display device;
adjust a rotation angle of the one or more rotatable slits based on the power generation time period; and
adjust a luminance of the transparent display based on the rotation angle of the one or more rotatable slits.

2. The display device of claim 1, further comprising a communication interface configured to communicate with a server, wherein the one or more instructions, when individually or collectively executed by the at least one processor, cause the display device to:
obtain weather information according to the installation position of the display device from the server, the weather information comprising solar altitude; and
adjust the rotation angle of the one or more rotatable slits according to the solar altitude during the main power generation time.

3. The display device of claim 1, further comprising one or more cameras configured to track a gaze of an occupant,
wherein the one or more instructions, when individually or collectively executed by the at least one processor, cause the display device to:
identify whether the occupant is gazing at the transparent display through the one or more cameras;
adjust the luminance of the transparent display to be less than a set luminance based on the occupant not gazing at the transparent display during the main power generation time; and
adjust the luminance of the transparent display to be greater than the set luminance based on the occupant gazing at the transparent display.

4. The display device of claim 3, wherein the one or more instructions, when individually or collectively executed by the at least one processor, cause the display device to adjust the luminance of the transparent display inversely proportional to the rotation angle of the one or more rotatable slits within a range less than the set luminance based on the occupant not gazing at the transparent display.

5. The display device of claim 1, further comprising a battery electrically connected to the one or more solar panels and configured to store power generated by a solar light, wherein the one or more instructions, when individually or collectively executed by the at least one processor, cause the display device to adjust the rotation angle of the one or more rotatable slits to a predetermined fixed angle according to a charge level of the battery during the sub power generation time.

6. The display device of claim 5, wherein the one or more instructions, when individually or collectively executed by the at least one processor, cause the display device to:
rotate the one or more rotatable slits to a first fixed angle based on the charge level of the battery being less than a set charge level; and
rotate the one or more rotatable slits to a second fixed angle based on the charge level of the battery being greater than the set charge level, and
wherein the first fixed angle is greater than the second fixed angle.

7. The display device of claim 6, further comprising one or more cameras configured to track a gaze of an occupant, wherein one or more the instructions, when individually or collectively executed by the at least one processor, cause the display device to:
identify whether the occupant is gazing at the transparent display through the one or more cameras;
during rotation of the one or more rotatable slits to the first fixed angle,
adjust the luminance of the transparent display to be less than a set luminance based on the occupant not gazing at the transparent display, and
adjust the luminance of the transparent display to be greater than the set luminance based on the occupant gazing at the transparent display.

8. The display device of claim 6, further comprising one or more cameras configured to track a gaze of an occupant, wherein one or more the instructions, when individually or collectively executed by the at least one processor, cause the display device to:
identify whether the occupant is gazing at the transparent display through the one or more cameras;
during rotation of the one or more rotatable slits to the second fixed angle,
output advertising content on the transparent display based on the occupant not gazing at the transparent display, and
output content according to a user request on the transparent display based on the occupant gazing at the transparent display.

9. The display device of claim 1, further comprising:
a communication interface configured to communicate with a server; and
one or more illuminance sensors configured to detect an ambient illuminance around the display device,
wherein the one or more instructions, when individually or collectively executed by the at least one processor, cause the display device to:
obtain weather information according to the installation position of the display device, the weather information comprising illuminance values by time period; and
adjust the luminance of the transparent display (by comparing a current illuminance detected by the one or more illuminance sensors with the illuminance values obtained from the server.

10. The display device of claim 9, wherein the one or more illuminance sensors comprise:
a first illuminance sensor facing the one or more rotatable slits; and
a second illuminance sensor facing outside of the display device.

11. The display device of claim 1, further comprising a camera configured to detect an external person adjacent to the display device, wherein the one or more instructions, when individually or collectively executed by the at least one processor, cause the display device to adjust the luminance of the transparent display to be greater than a second set luminance based on a distance between the display device and the external person obtained from the camera being less than a set distance.

12. The display device of claim 1, further comprising a temperature sensor configured to detect an ambient temperature around the display device, wherein the one or more instructions, when individually or collectively executed by the at least one processor, cause the display device to rotate the one or more rotatable slits to a third fixed angle based on a current temperature detected from the temperature sensor being greater than a set temperature.

13. A method for controlling a display device including a blind device including one or more rotatable slits and one or more solar panels on a surface of the corresponding slit and a transparent display provided behind the blind device, the method comprising:
identifying whether a power generation time period as a main power generation time or a sub power generation time based on an installation position of the display device;
adjusting a rotation angle of the one or more rotatable slits based on the power generation time period; and
adjusting a luminance of the transparent display based on the rotation angle of the one or more rotatable slits.

14. The method of claim 13, further comprising:
obtaining weather information according to the installation position of the display device from a server, the weather information comprising solar altitude; and
adjusting the rotation angle of the one or more rotatable slits according to the solar altitude during the main power generation time.

15. The method of claim 13, further comprising:
identifying whether an occupant is gazing at the transparent display through one or more cameras; and
during the main power generation time, adjusting the luminance of the transparent display to be less than a set luminance based on the occupant not gazing at the transparent display, and adjusting the luminance of the transparent display to be greater than the set luminance based on the occupant gazing at the transparent display.

16. The method of claim 15, further comprising adjusting the luminance of the transparent display inversely proportional to the rotation angle of the one or more rotatable slits within a range less than the set luminance based on the occupant not gazing at the transparent display.

17. The method of claim 13 further comprising:
adjusting the rotation angle of the one or more rotatable slits to a predetermined fixed angle according to a charge level of a battery during the sub power generation time.

18. The method of claim 17, further comprising rotating the one or more rotatable slits to a first fixed angle based on the charge level of the battery being less than a set charge level, and rotating the one or more rotatable slits to a second fixed angle based on the charge level of the battery being greater than the set charge level,
wherein the first fixed angle is greater than the second fixed angle.

19. The method of claim 18, further comprising:
identifying whether an occupant is gazing at the transparent display through one or more cameras; and
during rotation of the one or more rotatable slits to the first fixed angle, adjusting the luminance of the transparent display to be less than a set luminance based on the occupant not gazing at the transparent display, and adjusting the luminance of the transparent display to be greater than the set luminance based on the occupant gazing at the transparent display.

20. The method of claim 18, further comprising:
during rotation of the one or more rotatable slits to the second fixed angle, outputting advertising content on the transparent display based on an occupant not gazing at the transparent display, and outputting content according to user request on the transparent display based on the occupant gazing at the transparent display.
